(19) United States
(12) Patent Application Publication
(10) Pub. No.: US 2007/0230512 A1
(43) Pub. Date: Oct. 4, 2007

(54) Receiving apparatus and transmitting/receiving method

(75) Inventor: Shunichi Chiba, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/723,031

(22) Filed: Mar. 16, 2007

(30) Foreign Application Priority Data
Mar. 31, 2006 (JP) 2006-099721

(51) Int. Cl. H04J 3/06

(52) U.S. Cl. 370/509; 370/412

(57) ABSTRACT

According to one embodiment, there is provided a receiving apparatus including an interface section which receives a TTS (Transport stream with Time Stamp) packet via a network, a TTS packet buffer section which temporarily stores the TTS packet, a clock section which counts a clock signal, a monitor adjustment section which time-evaluates the TTS packet, and then, controls a clock speed of the clock section in accordance with the time evaluation, a decoding section which decodes the TTS packet in response to the clock signal, and then, outputs a TS packet, and an MPEG decoding section which MPEG-decodes the TS packet supplied from the TTS decoder.

### CROSS-REFERENCE TO RELATED APPLICATIONS

This application is based upon and claims the benefit of priority from Japanese Patent Application No. 2006-099721, filed Mar. 31, 2006, the entire contents of which are incorporated herein by reference.

### BACKGROUND

1. Field

One embodiment of the present invention relates to a transmitting/receiving apparatus and a transmitting/receiving method for obtaining synchronization of TSS packets between a transmitting apparatus and a receiving apparatus via a network such as the Internet.

2. Description of the Related Art

Currently, a technique of communicating packets via a network is widely known. At this time, reproduction of a stream or the like can be carried out without intermittence by obtaining predetermined synchronization between a transmitting side and a receiving side.

In Patent Document 1 (Jpn. Pat. Appln. KOKAI Publication No. 2003-258894), there is disclosed a data receiving/reproducing method for preventing an occurrence of an overflow or an underflow of a receiving buffer due to an asynchronous operating clock.

However, in Patent Document 1 that relates to a conventional technique, there is a problem that a method for efficiently obtaining synchronization of TTS (Transfer stream with Time Stamp) packets is not presented.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is s block diagram depicting an example of a configuration of an IP broadcast time synchronization system according to an embodiment of the present invention;

FIG. 2 is a model chart showing an example of feedback control of an IP broadcast time synchronization system according to an embodiment of the present invention;

FIG. 3 is an explanatory view showing an example of numeric value simulation in the case where a clock of an IP broadcast time synchronization system according to an embodiment of the present invention is earlier by 25 ppm;

FIG. 4 is an explanatory view showing an example of numeric value simulation in the case where a clock of an IP broadcast time synchronization system according to an embodiment of the present invention is delayed by 25 ppm;

FIG. 5 is a model chart showing an example of feedback control of an IP broadcast time synchronization system according to an embodiment of the present invention;

FIG. 6 is an explanatory view showing an example of numeric value simulation in the case where a clock of an IP broadcast time synchronization system according to an embodiment of the present invention is earlier by 25 ppm;

FIG. 7 is an explanatory view showing an example of numeric value simulation in the case where a clock of an IP broadcast time synchronization system according to an embodiment of the present invention is delayed by 25 ppm; and

FIG. 8 is a flowchart showing an example of clock synchronization procedures in an IP broadcast time synchronization system according to an embodiment of the present invention.

### DETAILED DESCRIPTION

Various embodiments according to the invention will be described hereinafter with reference to the accompanying drawings. In general, one embodiment of the present invention is to provide a receiving apparatus and a transmitting/receiving method for efficiently obtaining synchronization of TTS (Transfer stream with Time Stamp) packets via a network.

One embodiment of the present invention provides a receiving apparatus comprising: an interface section (21) which receives a TTS (Transport stream with Time Stamp) packet via a network; a TTS packet buffer section (25) which temporarily stores the TTS packet; a clock section (26) which counts a clock signal; a monitor adjustment section (24) which time-evaluates the TTS packet, and then, controls a clock speed of the clock section in accordance with the time evaluation; a decoding section (24) which decodes the TTS packet in response to the clock signal, and then, outputs a TS packet; and an MPEG decoding section (29) which MPEG-decodes the TS packet supplied from the TTS decoder.

In this manner, synchronization in TTS (Transfer stream with Time Stamp) packet communication between a transmitting apparatus and a receiving apparatus via a network can be efficiently obtained.

Now, embodiments of the present invention will be described in detail with reference to the accompanying drawings.

<Transmitting/Receiving System According to an Embodiment of the Present Invention>

(Configuration)

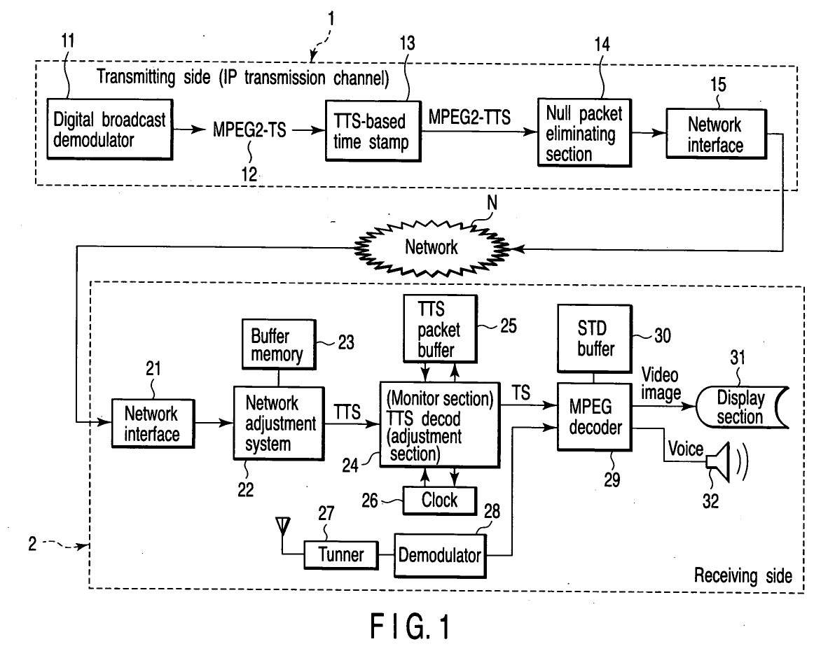

First, an example of a transmitting/receiving system will be described in detail with reference to FIG. 1. The transmitting/receiving system includes an IP transmission channel 1 and a receiving apparatus 2 connected via a network N such as the Internet.

Here, the IP transmission channel 1 has a digital broadcast demodulator 11, TTS-based time stamp 13, a Null packet elimination section 14, a network interface section 15 and the like.

In addition, the receiving apparatus 2 has a network interface section 21, a network adjustment system 22, a buffer memory 23, a TTS decoder 24, a TTS packet buffer 25, a clock section 26, a tuner 27, a demodulator 28, an MPEG decoder 29, an STD buffer 30, a display section 31, and a speaker 32.

<Clock Adjustment Method 1>

Failure

In digital broadcasting, MPEG2-TS obtained by multiplexing a video image and a voice is used. However, in the case where a TV broadcast is transmitted via radio waves, PCR (Program Clock Reference) is added thereto, and a signal is sent at a constant rate, thus enabling synchronization during transmission and receiving at a receiving side and preventing reproduction that is faster or slower than that of transmission data.

In contrast, in the case where MPEG2-TS is transmitted via a network, a signal cannot be sent at a constant rate. Thus, there is a possibility that a broadcast time lag occurs. As a method for avoiding this time lag, there is exemplified a method using MPEG2-TTS in which a time stamp (27 MHz) is added to each packet of MPEG2-TS.

A receiver stores TTS packets coming from a network in the TTS packet buffer 25, and then, outputs the accumulated TTS packets to the MPEG decoder at a timing at which a time stamp of each of the TTS packets coincides with a 27 MHz counter. However, there is a time lag between a “clock used by a transmitter 1 in order to assign a time stamp” and a “clock for a receiver 2 to evaluate a time stamp”, and thus, the TTS packet buffer of the receiver 2 increases or decreases due to such an error, and finally breaks.

Countermeasures

In order to prevent breakage of the TTS packet buffer, in an embodiment of the present invention, an occupying rate of TTS packets is evaluated in accordance with a packet accumulation time by means of a monitor section/adjustment section 24 of the TTS decoder 24. According to this evaluation result, a clock of the clock section 26 is varied. This avoids interruption of reproduction due to incomplete accumulation of packets in the TTS packet buffer.

That is, the receiver 2 evaluates a time stamp of a TTS packet by “27 MHz clock”+“offset”. Namely, output to the MPEG decoder 29 is carried out at a timing at which the time stamp of the TTS packet coincides with 27 MHz counter+“offset”. A value of this offset is controlled, thereby increasing or decreasing a speed of the “27 MHz clock” in a simulative manner.

In this manner, using an occupying quantity of the TTS packet buffers and its increase or decrease tendency, the time lag of the clock 26 is feedback-controlled, thereby avoiding breakage of the TTS packet buffer.

On the other hand, in the case where the occupying quantity of the TTS packet buffer has been evaluated by the number of packets (byte quantity), it is found that this evaluation is affected by a packet loss or a stream rate change. For example, even in the case where the clocks of the transmitter and receiver are completely synchronized with each other, occurrence of a packet loss in a network decreases the packet number (byte quantity) of the TTS packets accumulated in the TTS packet buffer. If a stream rate increases, the packet number (byte quantity) of the TTS packets accumulated in the TTS packet buffer increases. If a stream rate decreases, the packet number (byte quantity) of the TTS packets accumulated in the TTS packet buffer decreases. Therefore, even if the number of packets accumulated in the TTS packet buffer is evaluated, it is difficult to evaluate a time lag in clocks between the transmitter and the receiver.

In the present embodiment, in order to avoid such an influence due to a packet loss or a stream rate change, the occupying quantity of the TTS packet buffer is evaluated in accordance with an accumulation time by means of the monitor section/adjustment section 24 of the TTS decoder 24. In order to evaluate the accumulation time, the time stamp of the TTS packet is used. The time stamp of the TTS packet is on the order of 2 minutes 30 seconds per cycle (32 bits of 27 MHz). On the other hand, the TTS packet buffer is on the order of several seconds in buffer size. Thus, a accumulation time of the streams accumulated in the TTS packet buffer can be calculated merely by calculating a difference between time stamps of a first TTS packet and a last TTS packet of the TTS packet buffer 25.

<Clock Adjustment Method 2>

In an embodiment of the present invention, as another clock adjustment method, it is preferable to delay initial setting of a clock of the clock section 26 of the receiver 2, and then, in an initial state, to increase the TTS packet buffer 25 due to a time lag in clocks between the transmitter 1 and the receiver 2.

Due to such an intentional time lag in clock, an initial accumulation quantity can be determined without considering the fact that an accumulation quantity of the TTS packet buffer 25 may decrease. If the initial accumulation quantity can be decreased, a time from stream reception to video image display can be reduced.

However, if the accumulation quantity of the TTS packet buffer 25 continuously increases due to the time lag in clock, the TTS packet buffer 25 overflows and breaks. Therefore, when accumulation has been successfully made up to a safe level such that no problem occurs even if the accumulation quantity decreases due to the time lag in clock, the time lag in clock is controlled so that the accumulation quantity of the buffer is well balanced.

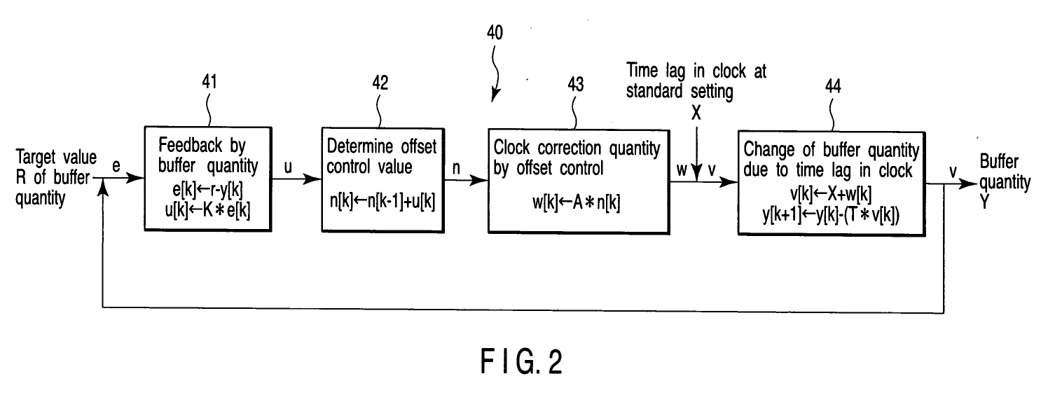

### First Embodiment: FIG. 2

A first embodiment shows a case of feedback control based on only the buffer accumulation quantity.

Let us consider a system for controlling a time lag V in clock in accordance with a method for N-adding an “offset” used for evaluating a time stamp of a TTS packet by a cycle τ.

In the case where a time lag in clock when N=0 (time lag in clock at standard time) is defined as X (in the case where X is a positive value, it denotes that a clock of a receiver is faster), the time lag V in clock can be expressed by the formula below (in the case where V is a positive value, it denotes that a clock of a receiver is faster).

V=X+(A×N), A=1/(27000000×τ)

For each cycle T, by using a difference E between a target accumulation quantity R and a current accumulation quantity Y of a TTS packet buffer, an operation quantity U of N is determined by the formula below, wherein K is a constant.

U=K×E, E=R−Y

For each cycle T, U is added to N, whereby the time lag V in clock is feedback-controlled.

By the time lag V in clock, the accumulation quantity Y of the TTS packet buffer decreases by T×V after a time T has elapsed.

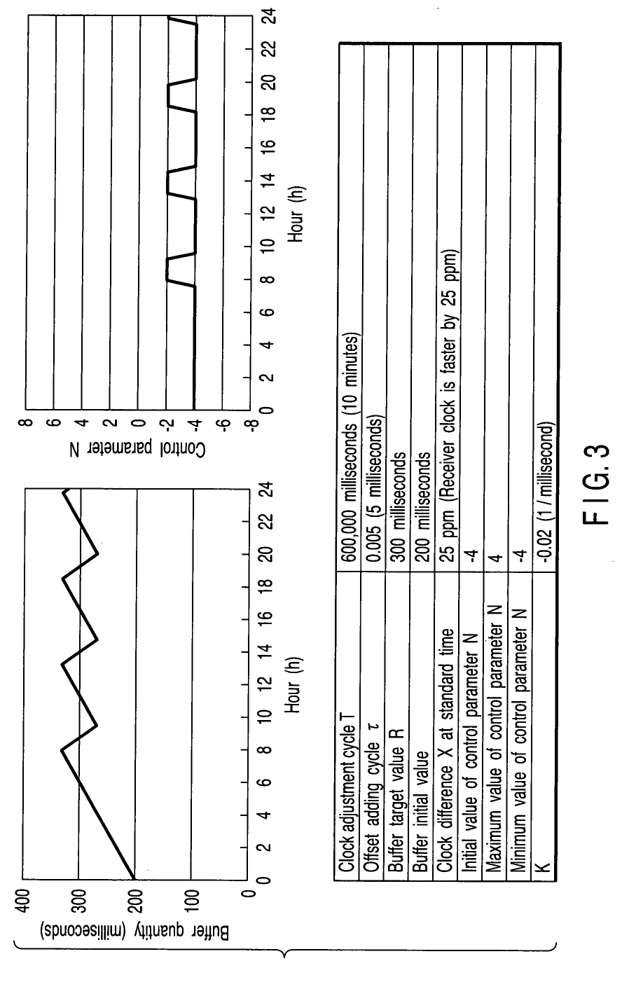

Simulation: FIG. 3

FIG. 3 shows a numeric value simulation in the case where T=600000 [milliseconds], τ=0.005 [seconds], K= 1/50 [/milliseconds], R=300 [milliseconds], initial value of N=−4, maximum value of N=4, minimum value of N=−4, initial value of Y=200 [milliseconds], and X=0.000025 (a clock of a receiver is faster by 25 ppm). An elapsed time is taken on the horizontal axis, and the accumulation quantity Y and the control parameter N are taken on the vertical axis.

Presuming that a time lag X in clock at standard time is within the range of ±30 ppm, the initial value of N is determined so that the accumulation quantity Y does not decrease in the initial state. In this example, the initial value of N is set to −4 so that an advantageous effect similar to a delay of 30 ppm in the receiver clock can be attained.

In the numeric value simulation of FIG. 3, because X=0.000025 is established, the initial value of the time lag V in clock is obtained as a negative value, 0.000025-4/(27000000×0.005)=−0.000005, and then, the accumulation quantity Y of the TTS packet buffer increases in the initial state.

While the accumulation quantity Y is smaller than the target accumulation quantity R, an operation quantity U is obtained as a negative value, and N decreases (however, N must be always equal to or greater than the minimum value). Therefore, while the accumulation quantity Y is smaller than the target accumulation quantity R, the accumulation quantity Y continuously increases.

If the accumulation quantity Y is greater than the target accumulation quantity R, the operation quantity U is obtained as a positive value, and N increases (however, N must be always equal to or smaller than the minimum value). Therefore, an increasing pace of the accumulation quantity Y decreases, and gradually, the accumulation quantity Y also decreases.

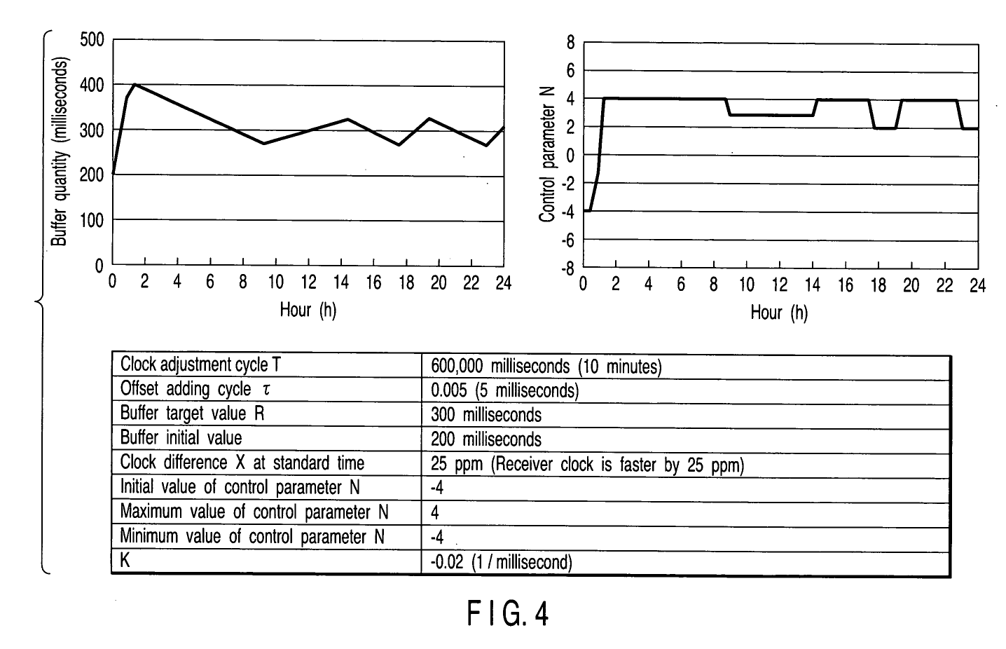

Simulation: FIG. 4

FIG. 4 shows a numeric value simulation under the same condition as that of the above simulation except that X=−0.000025 (receiver clock is slower by 25 ppm).

Because X=−0.000025 is established, the initial value of the time lag V in clock is −0.000025-4/(27000000×0.005)=−0.000055 that is a smaller value than that shown in the example of FIG. 3 and it is found that the accumulation quantity Y of the TTS packet buffer increases at a pace faster than that in the case of FIG. 3.

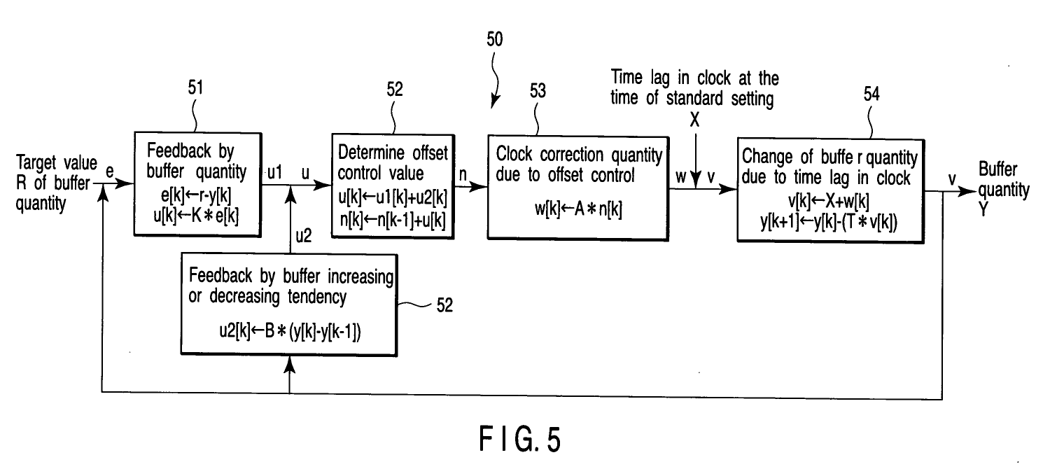

### Second Embodiment: FIG. 5

A second embodiment shows a case of feedback control based on a buffer accumulation quantity and its increase and decrease tendency.

An operation quantity U of N is determined by the formula below, depending on U1 determined by a difference E between a target accumulation quantity R and a current accumulation quantity Y, and U2 determined by a change rate dY of an accumulation quantity Y in a cycle T. B is a constant.

U=U1−U2

U1=K×E

U2=B×dY

In order to eliminate the change rate dY of the accumulation quantity Y, B is obtained by the formula below.

B=−1/(T×A)

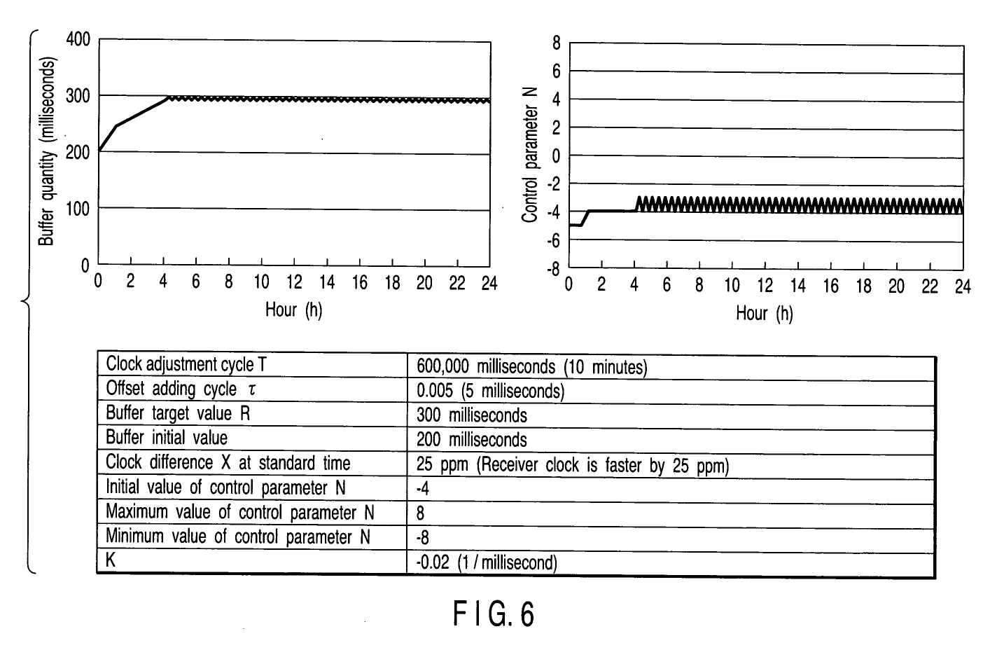

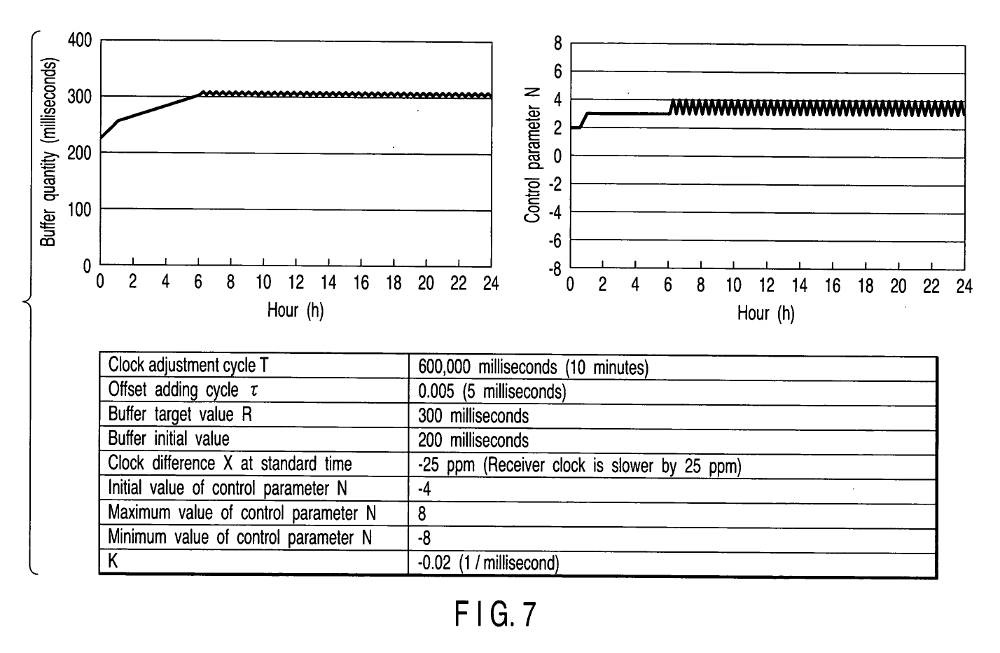

Simulation: FIGS. 6 and 7

FIG. 6 shows a numeric value simulation in the case of T=600000 [milliseconds], τ=0.005 [seconds], K=− 1/50 [/milliseconds], R=300 [milliseconds], initial value of N=−4, maximum value of N=8, minimum value of N=−8, initial value of Y=200 [milliseconds], and X=0.000025 (receiver clock is faster by 25 ppm). FIG. 7 shows a numeric value simulation under the same condition as that of the above simulation except that X=−0.000025 (receiver clock is slower by 25 ppm). An elapsed time is taken on the horizontal axis and the accumulation quantity Y and the control parameter N are taken on the vertical axis.

In the figures, it is found that the accumulation quantity Y stably converges into the target accumulation quantity R due to an advantageous effect of eliminating the change rate dY. Because of such stable convergence, it is found that the size of the TTS packet buffer can be reduced.

(Flowchart of Operation)

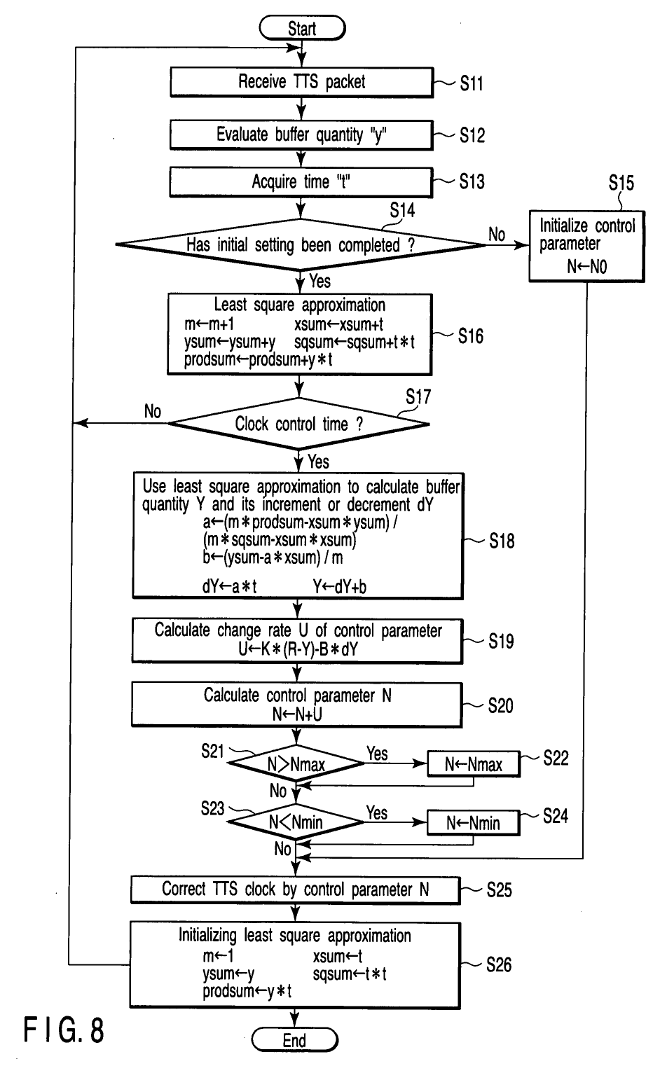

In order to attain an advantageous effect of a numeric value simulation, it is necessary to grasp an accumulation quantity Y and a change rate dY as precisely as possible. Therefore, as shown in the flowchart of FIG. 8, it is preferable that evaluation of the accumulation quantity Y and the change rate dY be carried out at an interval that is much shorter than a cycle T of clock control (be carried out at the time of TTS packet receiving in the flowchart of FIG. 8) and that least square approximation be carried out at a timing of carrying out clock control (at a timing of updating the control parameter N).

That is, when a TTS packet is received (step S11), a buffer quantity y is evaluated (step S12). After a time t is acquired (step S13), as long as initial setting is completed, least square approximation is obtained in accordance with the procedures as shown in step S16 of FIG. 8 (step S16).

When a clock control time has come (step S17), the buffer quantity Y and its increment and decrement dY are calculated using the least square approximation (step S18).

A change rate U of the control parameter is calculated (step S19), and then, the control parameter N is calculated (step S20).

Here, N is a value from Nmin to Nmax, and a TTS clock is corrected by the control parameter N (step S25). In this manner, it becomes possible to initialize the least square approximation (step S26).

As has been described above, according to the present embodiment, initial accumulation can be reduced while avoiding buffer breakage due to a time lag in clock. In addition, the accumulation quantity of a TTS packet buffer is stably converged, thereby making it possible to reduce the size of the TTS packet buffer.

The present invention can be achieved by one skilled in the art in accordance with a variety of embodiments described above. Further, it is obvious for one skilled in the art to conceive of a variety of modifications of these embodiments and to apply to a variety of embodiments even if they do not have inventive ability. Therefore, the present invention encompasses a broad range without deviating from a disclosed principle and novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A receiving apparatus comprising:
an interface section which receives a TTS (Transport stream with Time Stamp) packet via a network;
a TTS packet buffer section which temporarily stores the TTS packet;
a clock section which counts a clock signal;
a monitor adjustment section which time-evaluates the TTS packet, and then, controls a clock speed of the clock section in accordance with the time evaluation;
a decoding section which decodes the TTS packet in response to the clock signal, and then, outputs a TS packet; and
an MPEG decoding section which MPEG-decodes the TS packet supplied from the TTS decoder.

2. The receiving apparatus according to claim 1, wherein initial setting of the clock is set to be slower than a clock at a transmitting side over the network;

3. The receiving apparatus according to claim 1, wherein the monitor adjustment section detects an increasing or decreasing tendency of time evaluation of the TTS packet as well as time evaluation of the TTS packet, and then, controls a clock speed of the clock section in response to the detection.

4. The receiving apparatus according to claim 1, further comprising:
a tuner section which supplies to the MPEG decoding section a voice/video image signal obtained by demodulating an external broadcast signal;
a display device which displays on a screen a voice/video image signal outputted from the MPEG decoding section; and
a speaker section which reproduces a voice signal outputted from the MPEG decoding section.

5. The receiving apparatus according to claim 1, wherein the monitor adjustment section carries out the time evaluation based on a time stamp of the TTS packet.

6. The receiving apparatus according to claim 1, wherein the monitor adjustment section carries out the time evaluation by calculating a difference between first and last time stamps in the TTS packet buffer section.

7. A transmitting/receiving method between a transmitting apparatus and a receiving apparatus via a network, the method comprising:
transmitting a TTS (Transport stream with Time Stamp) packet from the transmitting apparatus via the network;
receiving the TTS packet via the network;
temporarily storing the TTS packet in a TTS packet buffer section;
time-evaluating the TTS packet, and then, controlling a clock speed in accordance with the time evaluation;
decoding the TTS packet in response to the clock signal, and then, outputting a TS packet; and
MPED-decoding the TS packet supplied from the TTS decoder.

8. The transmitting/receiving method according to claim 7, wherein initial setting of the clock is set to be slower than a clock at a transmitting side over the network.

9. The transmitting/receiving method according to claim 7, wherein an increasing or decreasing tendency of time evaluation of the TTS packet as well as time evaluation of the TTS packet is detected, and then, a clock speed of the clock section is controlled in response to the detection.

10. The transmitting/receiving method according to claim 7, wherein, in the receiving apparatus, there is further provided:
a tuner section which supplies to an MPEG decoding section a voice/video image signal obtained by demodulating an external broadcast signal;
a display device which displays on a screen a voice/video image signal outputted from the MPEG decoding section; and
a speaker section which reproduces a voice signal outputted from the MPEG decoding section.

11. The transmitting/receiving method according to claim 7, wherein the time evaluation is carried out based on a time stamp of the TTS packet.

12. The transmitting/receiving method according to claim 7, wherein the time evaluation is carried out by calculating a difference between first and last time stamps in the TTS packet buffer section.
